(19) United States
(12) Patent Application Publication
(10) Pub. No.: US 2014/0101143 A1
(43) Pub. Date: Apr. 10, 2014

(54) METHODS AND SYSTEMS FOR OBTAINING AND PRESENTING ALUMNI DATA

(71) Applicants: Yi Zhang, Santa Clara, CA (US); Christina Allen, Palo Alto, CA (US); Ashley Woodman Hall, Menlo Park, CA (US)

(72) Inventors: Yi Zhang, Santa Clara, CA (US); Christina Allen, Palo Alto, CA (US); Ashley Woodman Hall, Menlo Park, CA (US)

(73) Assignee: Linkedln Corporation, Mountain View, CA (US)

(21) Appl. No.: 13/647,027

(22) Filed: Oct. 8, 2012

(51) Int. Cl. G06F 17/30

(52) U.S. Cl. 707/723; 707/E17.014

(57) ABSTRACT

Obtaining alumni data from a database includes storing standardized alumni data in alumni data profiles, receiving a selected data entity representing an institution, searching the alumni data profiles to locate the profiles of alumni of the institution, determining a plurality of ranked sets of data by searching the profiles of alumni of the institution, and displaying each of the elements of the plurality of ranked sets of data respectively as elements in a plurality of facets. The elements in the plurality of facets may be displayed visually as a graphics display. A further operation may include receiving a selected data entity representing an element of a first facet and, responsive to receiving the selected data entity, displaying, at each of the facets of the plurality of facets other than the first facet, the elements of the facet ranked in order of the number of alumni in each element of the facet.

### TECHNICAL FIELD

The present disclosure generally relates to data processing systems and techniques for processing and presenting content within an online social network environment. More specifically, the present disclosure relates to methods and systems for analyzing and aggregating information relating to alumni, which could be alumni of universities, or alumni of other organizations. Such analysis and aggregation can provide a user with data about alumni such as their geographical area, their employer, their job function, and other matters.

### BACKGROUND

A social network service is a computer- or web-based application that enables its members or users to establish links or connections with persons for the purpose of sharing information with one another. In general, a social network service enables people to memorialize or acknowledge the relationships that exist in their “offline” (i.e., real-world) lives by establishing a computer-based representation of these same relationships in the “online” world. Many social network services require or request that each member, provides personal information about himself or herself, such as professional information including information regarding their educational background, employment positions that the member has held, and so forth. This information is frequently referred to as “profile” information, or “member profile” information. In many instances, social network services enable members, with the appropriate data access rights, to view the personal information (e.g., member profiles) of other members. Although such personal information about individual members can be useful in certain scenarios, it may not provide many insights into “big picture” questions about various professions, careers, and individual jobs or employment positions, among other things.

### DESCRIPTION OF THE DRAWINGS

Some embodiments are illustrated by way of example and not limitation in the Figures of the accompanying drawings, in which the same or similar reference numerals have been used to indicate the same or similar features unless otherwise indicated.

FIG. 1 is a functional block diagram illustrating various functional modules or components of a social/business network service, with which an embodiment described herein might be implemented;

FIG. 2 shows a user interface in the form of an interactive multi-attribute interactive pivot table that shows university alumni by geographical area, employer and job function according to an embodiment;

FIG. 3 shows a user interface in the form of an interactive multi-attribute interactive pivot table illustrating university alumni by employer according to an embodiment;

FIG. 4 shows a user interface in the form of an interactive multi-attribute interactive pivot table illustrating university alumni by geographical area, employer, and job function according to an embodiment;

FIG. 5 shows a user interface in the form of an interactive multi-attribute interactive pivot table illustrating university alumni by employer and by job function according to an embodiment;

FIG. 6 is a flow chart showing operation of a search algorithm that may be executed by a computer processor according to an embodiment;

FIG. 7 is a flow chart showing operation of another search algorithm that may be executed by a computer processor according to an embodiment;

FIG. 8 is a diagram of a college page in which the interactive pivot table is embedded; and

FIG. 9 is a block diagram of a machine in the form of a computing device within which a set of instructions, for causing the machine to perform any one or more of the methodologies discussed herein, may be executed.

### DETAILED DESCRIPTION

Methods and systems for obtaining and presenting information about members of a social network service who share in common matriculation at, and/or graduation from a particular school are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Knowing the career path that fellow alumni take after graduation is not easily learned. Upon graduating from or leaving a school, geographical distance and the passing of time often results in losing touch with alumni. But data about the geographical area where alumni live, who hires them, and what jobs they have obtained, among other data, can be important for fellow alumni, for universities, and for incoming students to universities. Such information is scarce and not easily acquired from public records. A student about to select a college may gain by knowing the paths of alumni of a given school to aid in the selection process. A student about to graduate from a university may gain by knowing what companies hire alumni from their university, and in what job functions, and in what geographical area. Alumni also gain from the same data about their fellow alumni. In any event, people, whether students or fellow alumni, can reach out to alumni for information about various subjects that the alumnus or alumna may know based on their career path, and the like. These items may be referred to herein as “cohorts,” or “facets.” A new framework may be used to obtain such alumni data by using data from a social network service on tens of millions of professionals, to obtain data on alumni such as geographical area, employer and job function, and other cohorts.

The embodiments have wider application than obtaining and presenting data with respect to university alumni. Those of ordinary skill in the art will recognize that the term alumni can mean graduates of a university, community college, high school or other school, former members of a club, former employees of a firm, or people formerly associated with other organizations. Further, alumni can mean veterans of the military. As used herein, university alumni will be used, but this is only for example purposes, and those of ordinary skill in the art will readily recognize that other uses of the word “alumni,” including the above suggestions, may be used.

Alumni data is valuable for enabling alumni to keep in touch with peers and other alumni, keep track of alumni events, leverage their network, recruiting, showing your college identity, finding the next job, and similar benefits.

Alumni data is valuable for college alumni offices by enabling them to engage and track alumni for relations, gift requests, and events.

Students selecting a college may want to determine what colleges send graduates to the top medical schools, or, what are career options for chosen major. Students nearing graduation may desire discovering what companies hire the most graduates in a given field of study, what cities have good jobs and what people the student may know in a given profession, where the student can obtain an internship by seeing internships other alumni of their school obtained, and the like.

Companies, too, benefit from being able to search for and view alumni of various schools. For example, companies benefit by being able to track college trends, provide insights to fields of study, and track competitor hiring, and for use in recruiting employees.

Alumni data may be obtained by a method that provides an electronic, interactive, multi-attribute, configurable, and highly scalable pivot table that uses data from a professional social network service to display alumni outcomes. These may be displayed by school, by city, by company, by job function, and by any other cohort for which standardized data is available from the social network service. This may be accomplished by searching, responsive to selection of a cohort, such as a school, the standardized data of the social network service to determine outcomes for the school such as number of alumni in a given geographical area, the companies that hired the alumni, the job functions of the alumni. The interactive pivot table may, while displaying the foregoing data, display personal information about the alumni in response to selection of the cohort. The cohort could be job function and the display may display the schools and their alumni that are employed in the function, by company and geographical location, or any other cohort desired for which there is standardized data in the social network service.

The above method is particularly useful since many social network services, and particularly those with a professional or business focus, request, or even require, members to provide various items of personal information, including information concerning a member's educational background, employment history and career. For example, a member may be prompted to provide information concerning the schools and universities attended, the dates or years of attendance, the subject matter concentration (e.g., academic concentration or major), as well as the professional certifications and/or academic degrees that the member has obtained. Similarly, a member may be prompted to provide information concerning the companies for which he or she has worked, the employment positions (e.g., job titles) held, the dates of such employment, the skills obtained, and any special recognition or awards received. The data that is requested and obtained may be structured, or unstructured. Other information may be requested and provided as well, such as a professional summary, which summarizes a member's employment skills and experiences, or an objective or mission statement, indicating the member's professional or career aspirations. For purposes of this disclosure, the above-described data or information is generally referred to as member profile data or member profile information. Furthermore, each individual item of data or information may be referred to as a member profile attribute.

Consistent with some embodiments, a social network service includes a people search information aggregation service, which is referred to hereinafter as the “people search module” or “people search application.” Consistent with some embodiments, the people search application analyzes and aggregates the member profile information of all (or some subset of) members of the social network service to provide a rich and easy to access set of tools that enables members to explore and discover a variety of ranking information, and possibly trends, concerning various schools as they relate to industries, professions, employments positions, and/or careers.

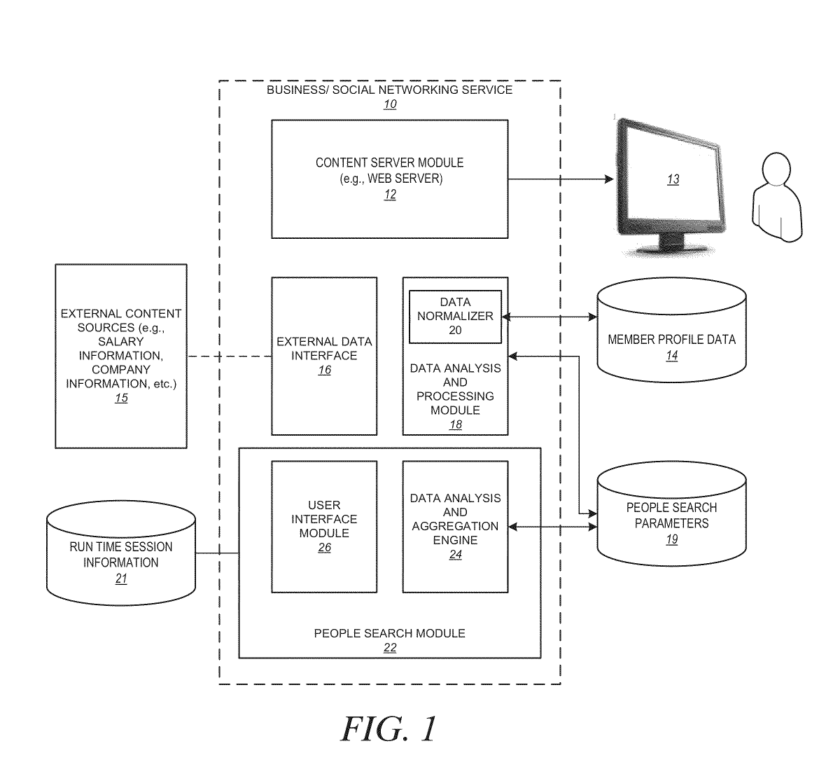

FIG. 1 is a functional block diagram illustrating various functional modules or components of a social/business network service 10, with which an embodiment might be implemented. The various functional modules illustrated in FIG. 1 may be embodied in hardware, software, or a combination thereof. Furthermore, although shown in FIG. 1 as a single set of modules, a skilled artisan will appreciate that with some embodiments, the individual components may be distributed amongst many server computers, forming a distributed, cluster-based architecture. In addition, as presented in FIG. 1, the people search application is represented as a module 22 integral with the social network service 10. In other embodiments, the people search application may be a separate web-based application that simply uses one or more sets of application programming interfaces (APIs) to leverage one or more separately hosted social network services.

As illustrated in FIG. 1, the social network service 10 includes a content server module (e.g., a web server module) 12 configured to send and receive information (e.g., web pages, or web-based content) with various web-based communication protocols to various client applications and devices, including web browser applications and/or other content rendering applications. With some embodiments, members interact with the service 10 via a web browser application, or some other content rendering application, that resides and executes on a client computing device, such as that with reference number 13 in FIG. 1. Client computing devices may include personal computers, as well as any of a wide number and type of mobile devices, such as laptop computers, tablet computers, mobile phones, and so forth. By interacting with the client computing device, a member can request and receive web pages from the service 10. With some embodiments, the web pages will prompt the member to provide various member profile attribute information (e.g., schools and/or universities attended, academic degrees received, academic majors, employment history information, and so forth), which, is then communicated to the service 10 and stored in a storage device as member profile data 14.

The service 10 includes an external data interface 16 to receive data from one or more externally hosted sources. For instance, with some embodiments, certain information about companies and/or particular job titles or employment positions (e.g., salary ranges) may be obtained from one or more external sources. With some embodiments, such data may be accessed in real-time, while in other embodiments the data may be imported periodically and stored locally at the social network service that is hosting the people search application.

With some embodiments, the volume of member profile data that is available for processing is extremely large. Accordingly, as shown in FIG. 1, with some embodiments, the social network service 10 includes a data analysis and processing module 18. With some embodiments, this processing module may be implemented with a distributed computing system, such as Apache™ Hadoop™ The processing module 18 obtains as input various attributes of member profile information, and then processes this information to ensure that is in a usable form for the people search application. For instance, the data normalizer module 20 will normalize various elements of data, ensuring that they conform to some standard that is used by the people search application. With some embodiments, the various job titles that members specify for themselves are normalized by deduplicating and disambiguating the job titles. For instance, in many cases, the same employment position will have a different job title at different companies. Accordingly, with some embodiments, the data normalizer module 20 will deduplicate job titles by mapping the different job titles, as specified in members' profiles, to uniquely named job titles for use with the people search application. In addition to deduplicating job titles, with some embodiments the data normalizer will disambiguate job titles. For instance, in many cases, a particular job title may be used in two different industries, such that the two employment positions represented by the same job title are really very different. A few examples include the job titles, “associate” and “analyst.” A financial analyst may be a completely different position from a security analyst, and so forth. Accordingly, with some embodiments, the data normalizer 20 will analyze various elements of a member's profile to determine the industry in which the member works, such that the job title for the member can be specified uniquely for that industry. The originally input data, before standardization, may be stored in case it is needed in the future to check standardization. In that instance it is a copy of the originally input data that may be used for standardization by data normalizer module 20.

In addition to normalizing various items of information, with some embodiments, the processing module 18 obtains or otherwise derives a set of people search parameters from or based on profile attributes of the members for use in ranking as discussed below. At least with some embodiments, these parameters are updated periodically (e.g., daily, nightly, bi-daily, weekly, every few hours, etc.) to take into account changes members make to their profiles.

People search parameters are stored for use with the people search application 22, as shown in FIG. 1 in a database with reference number 19. With some embodiments, the people search parameters are stored in a distributed key-value storage system, such as the open sourced storage system known as the Voldemort Project. Also illustrated in FIG. 1 is a data analysis and aggregation engine with reference number 24 which is used to process the people search parameters to obtain ranking results as discussed below. At run-time, the people search parameters are quickly retrieved, and then used with one or more sets or one or more vectors to determine ranking of schools, which may be provided to a member interface in absolute or weighted format. With some embodiments, the profile attributes specified by the member for use with the people search application may be separately stored with run-time session information, as illustrated in FIG. 1 with reference number 21.

As illustrated in FIG. 1, the people search module 22 includes a data analysis and aggregation engine 24, and a user interface (UI) module 26. The data analysis and aggregation engine analyzes and aggregates the people search parameters as discussed in greater detail below. The user interface module 26 includes logic for presenting the information in various formats, for example, as shown in the example user interfaces presented in the attached figures.

Certain attribute information from the member profiles of members of a social network service are retrieved and analyzed for the purpose of normalizing the information for use with the people search application. For instance, with some embodiments, job titles may be specified (as opposed to selected) by the members of the social network service and therefore will not be standardized across companies and industries. As such, with some embodiments, a normalizer module will analyze the profile information from which certain job titles are extracted to ascertain an industry specific job title. Accordingly, with some embodiments, the people search application will utilize a set of unique, industry specific job titles. Of course, other attributes beside job titles will also be normalized.

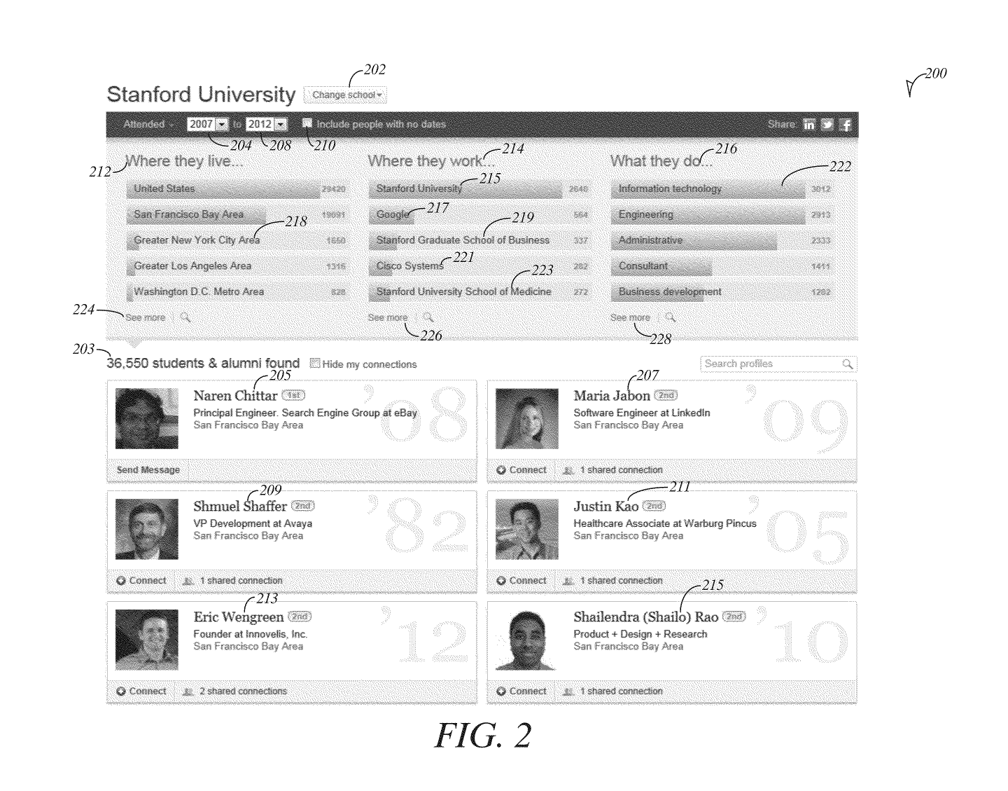

FIG. 2 shows a user interface in the form of an interactive multi-attribute interactive pivot table 200 that shows university alumni by attributes of geographical area, employer, and job function according to an embodiment. Other attributes may be used as desired. In the example, the user has chosen to obtain alumni data about alumni of Stanford University. The school may be selected, in one embodiment, by way of drop down menu 202. The drop down menu 202 may have a menu of schools displayed for selection. After selection, the school would appear in the title area where Stanford University appears in FIG. 2. Alternatively, the drop down menu 202 may provide a field for entering the name of the school which, when selected, appears in the title area. The embodiment seeks alumni data for Stanford alumni who graduated between the years 2007, selected at drop down menu 204, and 2012, selected at drop down menu 208. Alumni who did not specify a year of graduation could be included if desired by selecting item 210. The facets investigated are where the alumni live, 212, where they work, 214, and what they do, 216. The latter facet may be viewed as representing job function. The facets investigated are not limited to those indicated at 212, 214, and 216 but may also include any facet for which data is available from the social network service As indicated at 203, of FIG. 2, the system determines, by searching profile data of members of the social networking service that has been standardized as discussed above, that there are 36,550 students and alumni found who graduated from Stanford between 2007 and 2012. Under the facet 212 are seen the geographical areas in which the alumni are located in ranked order in accordance with the number of alumni in each location. At 214 are shown the companies at which the 36,550 students and alumni work or, in the case of students, study, ranked by the number of members employed by the companies. Images of these alumni are displayed, if available, as at 205, 207, 209, 211, 213, 215. More images can be seen by extending the web page downwardly, by selecting a “See more” icon that may be provided. A selectable icon that may be at each of the individual alumni images will allow the user to browse the alumni's social network service profile. Alternatively, the image of each alumni may itself be clickable to allow access to the alumni's profile. Facet 216 shows the jobs or, alternatively, the function, the alumni are engaged in, ranked by the number of alumni in each job category. Although only five elements are shown under each facet, the display is extendable by clicking on “See more” icons 224, 226, 228, to see all of the elements under the above three facets.

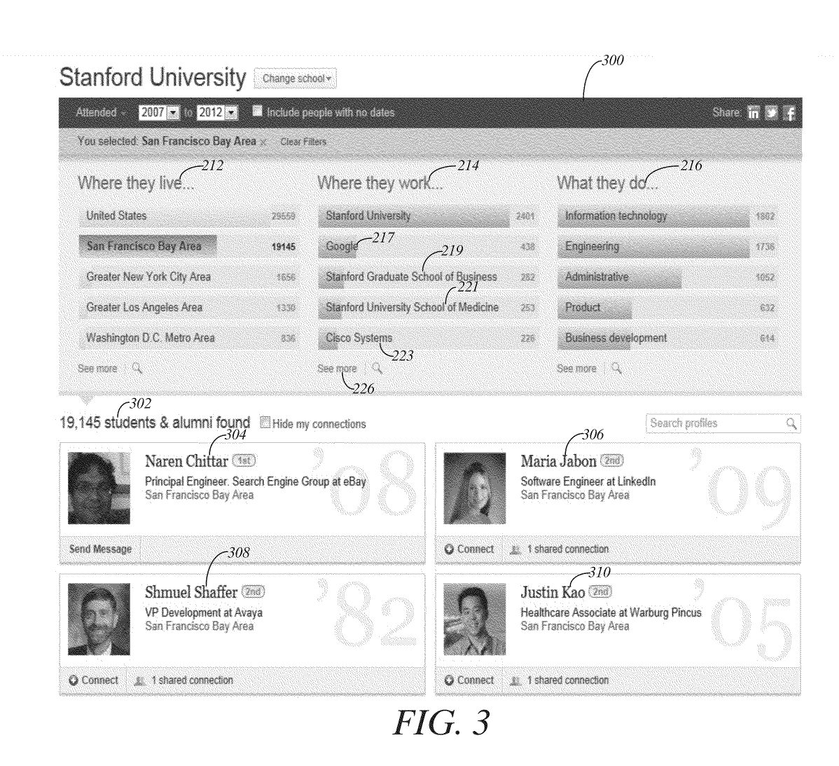

If the user now clicks on San Francisco Bay Area 218, “where they live,” the system searches for all Stanford alumni in the San Francisco Bay Area and finds, as illustrated at 302 in the interactive pivot table 300 of FIG. 3, that there are 19,145 students and alumni found in the San Francisco Bay Area. The “where they work” facet 214, shows that 2401 work at (or study at, since some members of the social network service are students) Stanford University 215, that 438 work at Google 217, that 282 or work at Stanford Graduate School of Business 219, that 253 study or work at Stanford University School of Medicine 221, that 226 work at Cisco Systems 223. Additional employers may be seen by clicking on “See more” 226. The employees employed in the San Francisco Bay Area are displayed at 304, 306, 308, and 310, with the remaining employees in this category being displayed by expanding the page of FIG. 3.

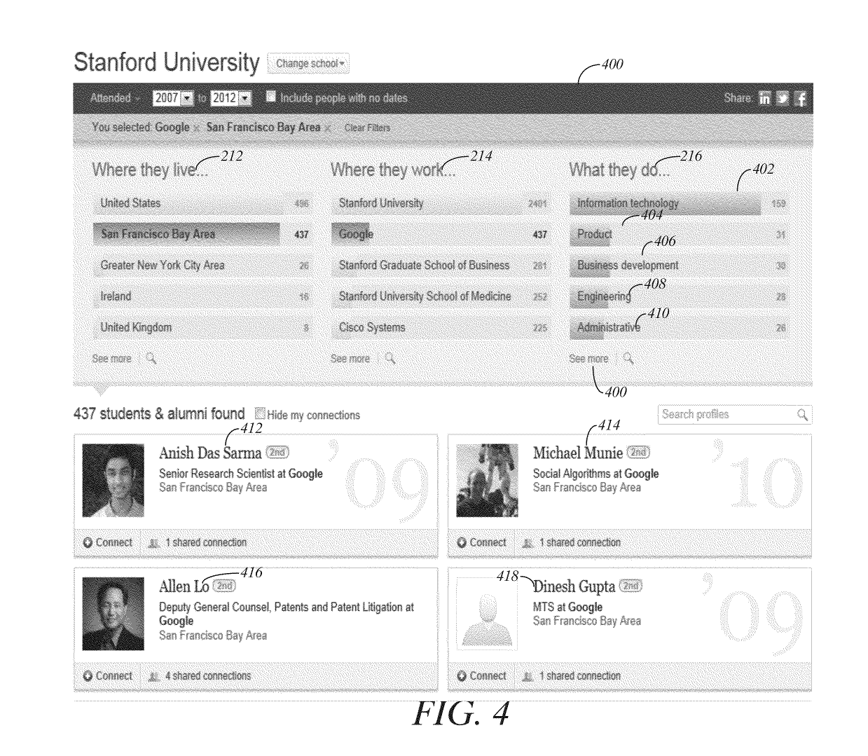

Responsive to the user now clicking on, as one example, Google, 217, in FIG. 3, the system will search to find San Francisco Bay Area Stanford alumni employed by Google under the “What they do” facet, and will display at 402 of interactive pivot display table 400 of FIG. 4 that 159 are employed by Google in the San Francisco Bay Area in Information technology, 404 shows that 31 Stanford alumni are employed by Google in the San Francisco Bay Area in Product development, 406 shows that 30 Stanford Alumni are employed by Google in the San Francisco Bay Area in Business development, 408 shows that 28 Stanford Alumni are employed by Google in the San Francisco Bay Area in Engineering, and 410 shows that 26 Stanford alumni are employed by Google in the San Francisco Bay Area in Administrative. More job functions may be seen by expanding the page by clicking on “See more” at 228. The employees employed by Google in the San Francisco Bay Area are displayed at 412, 414, 416, and 418, with the remaining alumni employed by Google in the San Francisco Bay Area being displayed by expanding the page of FIG. 4.

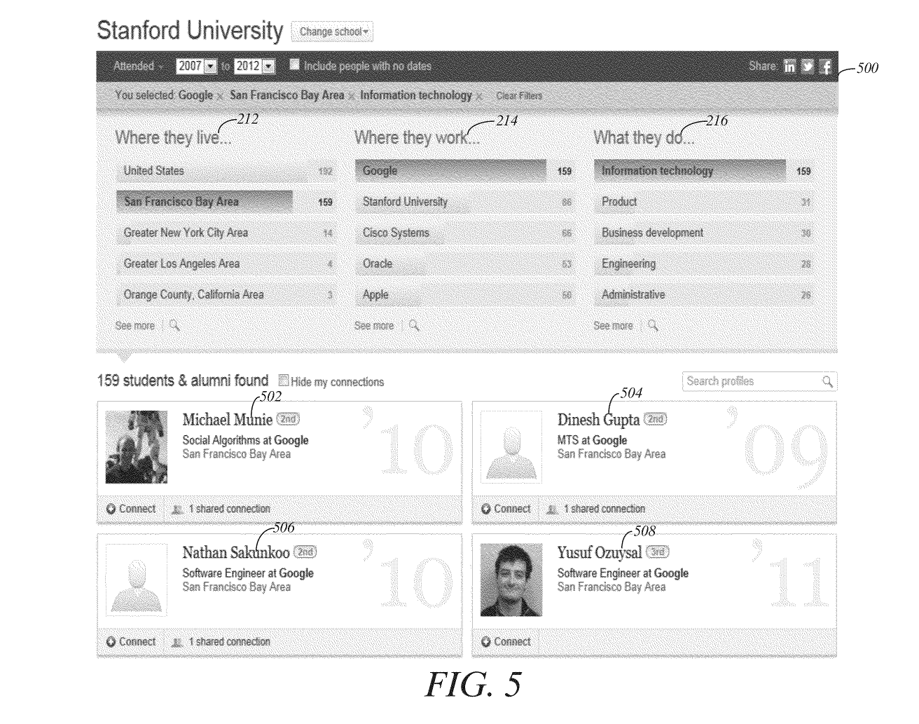

If the user now clicks on Information Technology 402 of FIG. 4, the system will search and display the number of Stanford Alumni who are employed by Google in the San Francisco Bay Area in Information Technology as 159 under What they do, 216. Images and/or other meta data of these employees are displayed beginning at 502, 504, 506, and 508 of the interactive pivot table of FIG. 5, with the foregoing information of the remaining Stanford alumni that are employed in Information Technology at Google in the San Francisco Bay Area being displayed by expanding the page of FIG. 5 downwardly.

The facet presentation design in this embodiment is a data visualization component. FIGS. 2-5 allow a member to view a graphical dimension to the communication of the data set that is used to provide the information displayed on FIGS. 2-5. The ability to see this data set as presented in the facets of FIGS. 2-5 helps the user easily to recognize relationships between and among facets and to see the “bigger picture” of the data set at a glance. In the figures this is represented as bar graphs under 212, 214, and 216 in FIGS. 2-5. But the visualization could also be a timeline, map, bubble race, tag cloud or many other graphic methods used to represent data sets. The graphic is presented in a manner that allows the viewer to see immediately the relationship among where alumni are located, where the alumni work, and what the alumni do professionally.

As mentioned above, in one embodiment veterans of the military can also be considered alumni, with the branch of the military, army, navy, air force, marines, and other branches, being considered the organization, much like a school. Each of these branches could be used instead of schools in the user interface of FIGS. 2 through 5. This may be done by providing selectable icons that allow the user to view alumni data as described above, for a particular branch of the military.

### Flowchart

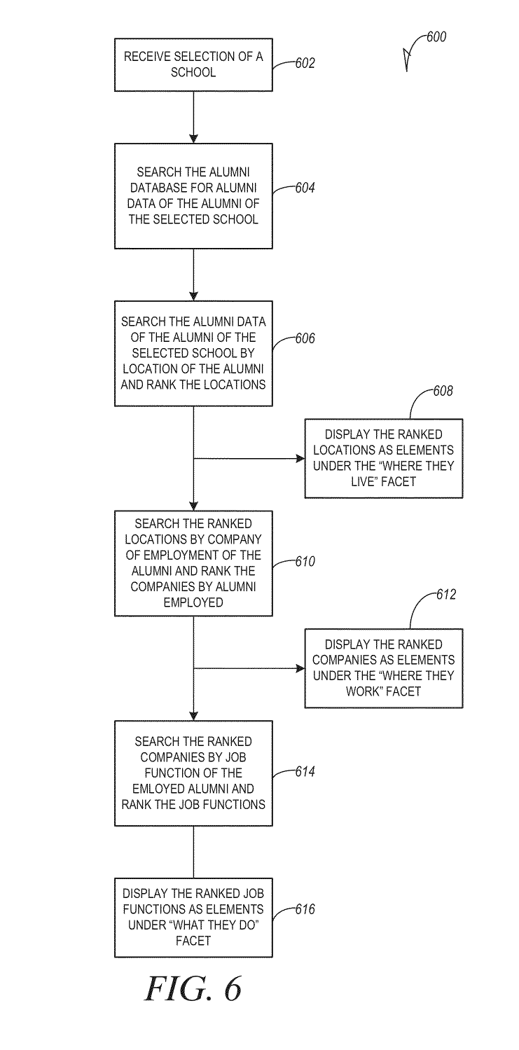

FIG. 6 illustrates operation of method 600 for providing an interactive pivot table according to an embodiment using people search parameters such as described with respect to FIG. 1. At 602 the system receives a selected data entity representing a school. This may be done by a user selecting Stanford from the drop down menu 202 of FIG. 2 and designating the desired years of graduation at 204 and 208. This data entity may be standardized upon being received, or may be standardized as part of the search process described next. At 604 the system searches the social network service database 14 of FIG. 1 to find standardized alumni profiles for the alumni who graduated from Stanford in the specified years. The profiles may be stored in people search parameters database 19 for further searching, or may be searched directly from member profile database 14, as desired. At 606 a search is made of the alumni data that were located at 604. The search is by geographical location of the alumni, again using the standardized data of the member profiles for the search. The geographical locations found in the search are ranked by number of alumni located in each location. At 608 the ranked locations are displayed as elements under the Where They Live facet 212 of FIG. 3. Images and profile data of the alumni associated with facet 212 may also be displayed as discussed above.

At 610 the ranked geographical locations found in 606 are searched by company of employment of the alumni in each location. The companies are then ranked by number of alumni employed by each company. At 612 the ranked companies are displayed under “Where they work,” 214 of FIG. 3. The ranked companies are searched by job function at 614 and the job functions are ranked by the number of alumni in each job function. The ranked job functions are displayed under “What They Do,” 216 of FIG. 4. Images and profile data of the employees at those job functions may also be displayed as disused above. Upon selecting any entry, which may also be considered selecting an element, of a first facet as described above, the system displays the elements of the other two facets corresponding to the selected element of the first facet. As mentioned above, in the current example only three facets 212, 214, and 216 are described. However, those of ordinary skill in the art will recognize that any number of facets may be used so long as the standardized data for the facets is found in the social network service database. In each of steps 608, 612, and 616, the data associated with the rankings, and images and profile data of the alumni associated with the rankings may be stored for display when needed to respond to a selection of an element as described below. The ranked data and images displayed and stored in connection with steps 608, 612, and 614 may be considered a plurality of ranked sets of data.

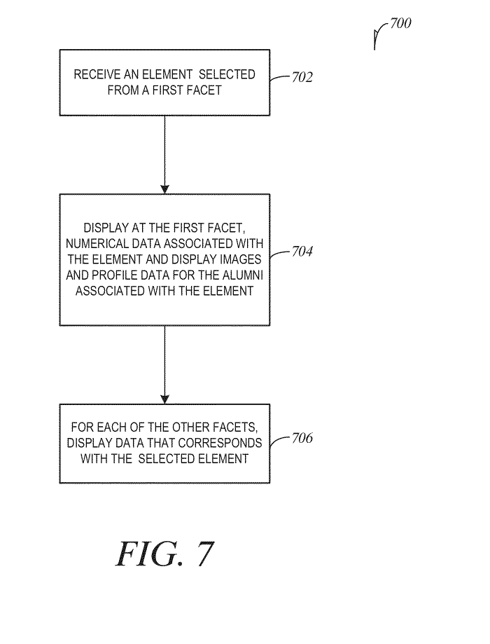

FIG. 7 illustrates method of operation 700 of an interactive pivot table according to an embodiment. At 702 a data entity representing an element is selected from a first facet such as 212, or 214, or 216 of FIG. 2 and data representing the element is received by the system. At 704, responsive to receiving the data representing the selected entry, the system displays at the first facet images and profile data for alumni associated with the selected element. If desired, numerical data associated with the selected element may be also displayed at the first facet. This is as discussed with respect to the example of selection of San Francisco Bay Area as described above with respect to FIG. 2. As one example, if it is desired to find the location of alumni of Stanford in the San Francisco Bay Area then the selected element may be San Francisco Bay Area 218 of FIG. 2. The system then determines, by searching profile data of members of the social networking service that has been standardized as above, that there are 19,141 students and alumni found in the San Francisco Bay Area. This is seen in FIG. 3. Under the facet 212 of FIG. 3 are seen displayed images and profile data, 205, 207, 209, 211, 213, 215, and others on extensions of the page, of alumni represented in the selected element 218. That is, images and profile data of alumni located in the San Francisco Bay Area are displayed.

At 706, responsive to receiving the selected element, the system also searches member profiles and displays at each of the other facets the data that corresponds to the selection of the element. This may be seen, for example, at the above discussion of FIG. 3 where the companies at which the alumni work in the San Francisco Bay Area are displayed in ranked order under facet 214, and what the alumni do at the companies where they work in the San Francisco Bay Area are displayed in ranked order under facet 216.

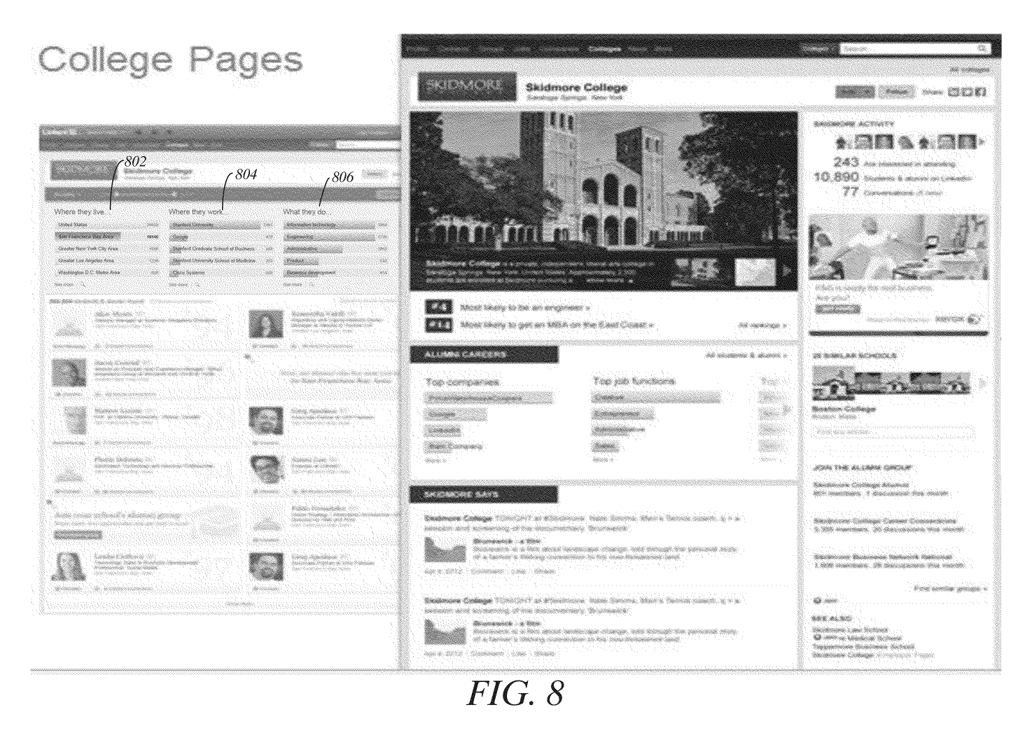

FIG. 8 is an illustration of a college page that provides information about a particular college. The interactive pivot table, including facets 802, 804, and 806, is embedded in the college page. Visitors to the college page who are seeking information about the college may operate the interactive pivot table as described above to find information about the college to the extent of the data included in the alumni profile of social network service.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

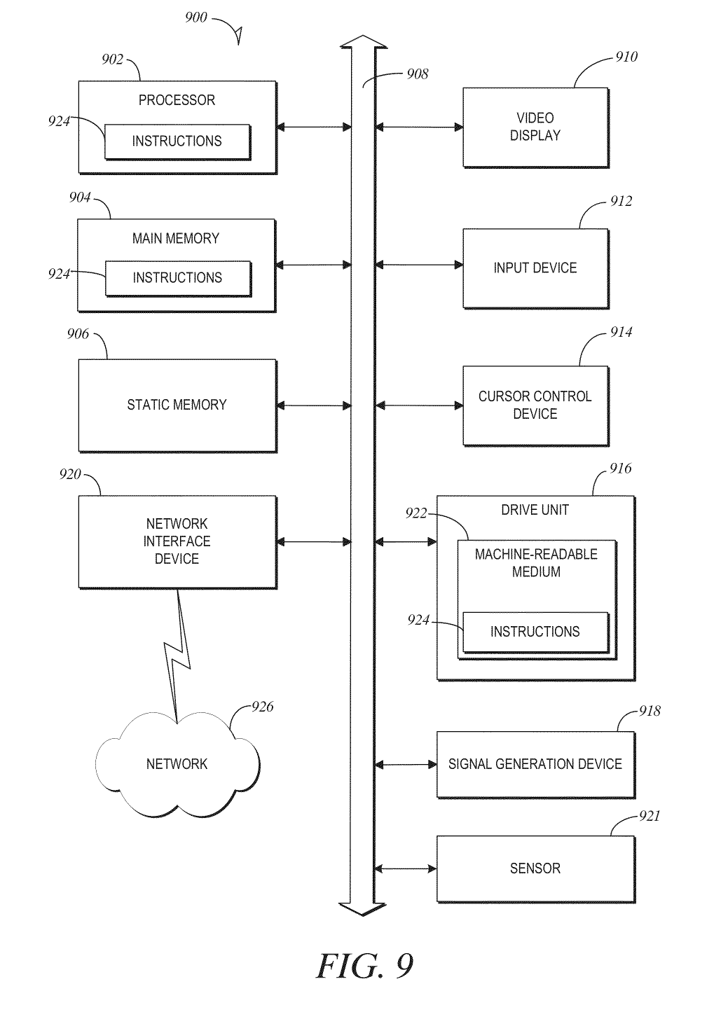

FIG. 9 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 901 and a static memory 906, which communicate with each other via a bus 908. The computer system 900 may further include a display unit 910, an alphanumeric input device 917 (e.g., a keyboard), and a user interface (UI) navigation device 911 (e.g., a mouse). In one embodiment, the display, input device and cursor control device are a touch screen display. The computer system 900 may additionally include a storage device 916 (e.g., drive unit), a signal generation device 918 (e.g., a speaker), a network interface device 920, and one or more sensors 921, such as a global positioning system sensor, compass, accelerometer, or other sensor.

The drive unit 916 includes a machine-readable medium 922 on which is stored one or more sets of instructions and data structures (e.g., software 923) embodying or utilized by any one or more of the methodologies or functions described herein. The software 923 may also reside, completely or at least partially, within the main memory 901 and/or within the processor 902 during execution thereof by the computer system 900, the main memory 901 and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 923 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
using at least one processor, storing standardized alumni data in alumni data profiles;
receiving a selected data entity representing an institution;
searching the alumni data profiles in response to receiving the selected data entity, to locate the profiles of alumni of the institution;
determining a plurality of ranked sets of related data elements by searching the profiles of alumni of the institution; and
displaying each of the elements of the plurality of ranked sets of related data elements respectively as elements in a plurality of facets.

2. The method of claim 1 wherein the elements in the plurality of facets are displayed visually as related facets a graphics display.

3. The method of claim 1 wherein the institution is one of the group consisting of a school, a company, a firm, a club, and a branch of the military.

4. The method of claim 1 further comprising receiving a selected data entity representing an element of a first facet; and
responsive to receiving the selected data entity displaying, at each of the facets of the plurality of facets other than the first facet, the elements of the facet ranked in order of the number of alumni in each element.

5. The method of claim 4 wherein profile data of alumni represented in the selected data entity are displayed at the first facet.

6. The method of claim 5 wherein the related data elements of the first facet represent job function, and the related data elements of at least two of the plurality of facets other than the first facet respectively represent schools and companies.

7. The method of claim 5 wherein the related data elements of the first facet represent location and the related data elements of at least two of the plurality of facets other than the first facet respectively represent companies and job functions.

8. The method of claim 5 wherein the related data elements of the first facet represent companies and the related data elements of at least two of the plurality of facets other than the first facet respectively represent schools and job functions.

9. The method of claim 5 wherein the related data elements of the first facet represent job functions and the related data elements of at least two of the plurality of facets other than the first facet respectively represent companies and locations.

10. The method of claim 5 wherein the plurality of facets is included in a web page associated with a college.

11. A machine-readable storage device having a stored set of instructions which, when executed by the machine, causes the machine to execute the following operations:
storing standardized alumni data in alumni data profiles;
receiving a selected data entity representing an institution;
searching the alumni data profiles in response to receiving the selected data entity, to locate the profiles of alumni of the institution;
determining a plurality of ranked sets of data by searching the profiles of alumni of the institution; and
displaying each of the elements of the plurality of ranked sets of data respectively as elements in a plurality of facets.

12. The machine-readable storage device of claim 11 wherein the elements in the plurality of facets are displayed visually as related facets in a graphics display.

13. The machine-readable storage entity of claim 11 wherein the institution is one of the group consisting of a school, a company, a firm, a club, and a branch of the military.

14. The machine-readable storage entity of claim 11 the operations further comprising receiving a selected data entity representing an element of a first facet; and
responsive to receiving the selected data entity displaying, at each of the facets of the plurality of facets other than the first facet, a data set of the facet ranked in order of the number of alumni in each element.

15. The machine-readable storage entity of claim 14 wherein profile data of alumni represented in the selected data entity are displayed at the first facet.

16. The machine-readable storage entity of claim 15 wherein the related data elements of the first facet represent job function, and the related data elements of at least two of the plurality of facets other than the first facet respectively represent schools and companies.

17. The machine-readable storage entity of claim 15 wherein the related data elements of the first facet represent location and the related data elements of at least two of the plurality of facets other than the first facet respectively represent companies and job functions.

18. The machine-readable storage entity of claim 15 wherein the related data elements of the first facet represent companies and the related data elements of at least two of the plurality of facets other than the first facet respectively represent schools and job functions.

19. The machine-readable storage entity of claim 15 wherein the related data elements of the first facet represent job functions and the related data elements of at least two of the plurality of facets other than the first facet respectively represent companies and locations.

20. The machine-readable storage entity of claim 15 wherein the plurality of facets is included in a web page associated with a college.

21. A system comprising at least one processor configured to:
store standardized alumni data in alumni data profiles;
receive a selected data entity representing an institution wherein the institution is one of the group consisting of a school, a company, a firm, a club, and a branch of the military;
search the alumni data profiles in response to receiving the selected data entity, to locate the profiles of alumni of the institution;
determine a plurality of ranked sets of data by searching the profiles of alumni of the institution; and
display each of the elements of the plurality of ranked sets of data respectively as elements in a plurality of related facets;
receive a selected data entity representing an element of a first facet; and
responsive to receiving the selected data entity display, at each of the facets of the plurality of facets other than the first facet, the elements of the facet ranked in order of the number of alumni in each element of the facet.

22. The system of claim 19 wherein the plurality of facets include one of a group consisting of the related data elements of the first facet represent job function, and the related data elements of at least two of the plurality of facets other than the first facet respectively represent schools and companies; the related data elements of the first facet represent location and the related data elements of at least two of the plurality of facets other than the first facet respectively represent companies and job functions; the related data elements of the first facet represent companies and the related data elements of at least two of the plurality of facets other than the first facet respectively represent schools and job functions; and the related data elements of the first facet represent job functions and the related data elements of at least two of the plurality of facets other than the first facet respectively represent companies and locations.
